(19) United States
(12) Patent Application Publication
(10) Pub. No.: US 2024/0042540 A1
(43) Pub. Date: Feb. 8, 2024

(54) WELDING DEVICE

(71) Applicant: Hilti Aktiengesellschaft, Schaan (LI)

(72) Inventors: Rolf ERHARDT, Buchs SG (CH); Julia ZIELBAUER, Rüthi (CH); Sigrid ANDREAE, Azmoos (CH)

(21) Appl. No.: 18/266,637

(22) PCT Filed: Dec. 1, 2021
(86) PCT No.: PCT/EP2021/083777

§ 371 Date: Jun. 12, 2023

(30) Foreign Application Priority Data
Dec. 17, 2020 (EP) 20214831.8

(51) Int. Cl. B23K 9/20; B23K 9/32

(52) U.S. Cl. CPC B23K 9/201; B23K 9/325

(57) ABSTRACT

A welding device for welding a stud to a substrate along a welding axis in a welding direction, comprising an inert gas cover with an inert gas inlet arranged as a ring around the axis, with an inert gas outlet, and an opening facing the welding direction, the opening having transversely to the welding direction an opening diameter, wherein the inert gas inlet is at an inlet distance from the opening counter to the welding direction, wherein the inert gas outlet is at an outlet distance from the opening counter to the welding direction, and a holding device holding the stud within the cover during welding, the holding device having an outside diameter and a stud receptacle with an inside diameter, wherein the outlet distance is at least half of a difference between the opening diameter and the outside diameter or at least the same size as the inlet distance.

### TECHNICAL FIELD

The invention relates generally to a welding device for welding a welding stud to a substrate along a welding axis in a welding direction. The invention relates in particular to a welding gun.

### PRIOR ART

There are numerous known devices and methods by which various studs are fastened to a substrate in different applications. For example, a stud is brought into contact with the substrate and an electrical current is applied to it. For this purpose, the stud is held by an electrically conductive stud holder. As soon as the electrical current flows between the stud and the substrate, the stud is lifted off the substrate to form an arc. The energy that is released causes the material of the stud and the substrate to be partially liquefied. The electrical current is then switched off and the stud is immersed into the liquefied material while this material cools down and becomes solid. The stud is then connected to the substrate in an integrally bonded manner.

In order to provide the necessary energy for liquefying the material of the stud and the substrate in a sufficiently short time, there are known devices that generate an electrical current of a very high current intensity and use a correspondingly rated electrical cable to feed it to the stud. To avoid oxidizing of the liquefied material, it is known to suffuse the contact point between the stud and the substrate with an inert gas. The inert gas in this case flows past the welding point with the liquefied material and displaces from the ambient air the oxygen which under some circumstances is present there.

In the case of applications in building construction or shipbuilding for example, studs of various sizes with a thread to which an item is screwed are used in order to fasten the item to the substrate.

### SUMMARY OF THE INVENTION

The object of the invention is to provide a device with which fastening of a stud to a substrate is improved.

This object is achieved using a welding device for welding a welding stud to a substrate along a welding axis in a welding direction, comprising an inert gas cover with an inert gas inlet arranged in the form of a ring around the welding axis, with an inert gas outlet, and with an opening facing in the welding direction, wherein the opening has transversely to the welding direction an opening diameter, wherein the inert gas inlet is at an inlet distance from the opening counter to the welding direction, wherein the inert gas outlet is at an outlet distance from the opening counter to the welding direction, further comprising a holding device for holding the welding stud within the inert gas cover during a welding operation, wherein the holding device has an outside diameter and a stud receptacle with an inside diameter, wherein the outlet distance is at least half of a difference between the opening diameter and the outside diameter. Likewise, the object is achieved if the outlet distance is at least the same size as the inlet distance. The welding device is preferably formed as a welding gun. It is ensured, by the arrangement of the inert gas inlet in the form of a ring and the arrangement of the inert gas outlet at a distance from the opening, that the inert gas flows uniformly from all directions radially to the welding point and then essentially axially away from the welding point.

An advantageous embodiment is characterized in that the outlet distance is at least half of the difference between the opening diameter and the inside diameter or is at least the same size as the inlet distance. A further advantageous embodiment is characterized in that the outlet distance is at least half of the difference between the opening diameter and the outside diameter and is at least half the size of the inlet distance.

An advantageous embodiment is characterized in that the inert gas inlet is directed onto a radially outer region of the opening in order to generate a flow of inert gas along the opening radially to the setting axis when the opening is covered.

An advantageous embodiment is characterized in that the inert gas inlet comprises an inlet opening in the form of a ring surrounding the welding axis. An alternative embodiment is characterized in that the inert gas inlet comprises a multiplicity of inlet openings arranged in the form of a ring around the welding axis.

An advantageous embodiment is characterized in that the inert gas outlet comprises a multiplicity of outlet openings arranged in the form of a ring around the welding axis. The inert gas outlet is preferably arranged offset from the inert gas inlet in a direction transverse to the welding axis. A further advantageous embodiment is characterized in that the inert gas outlet leads radially with respect to the welding axis through the inert gas cover outward into the surrounding area.

### EXEMPLARY EMBODIMENTS

The invention will be explained in more detail below on the basis of exemplary embodiments with reference to the drawings, in which:

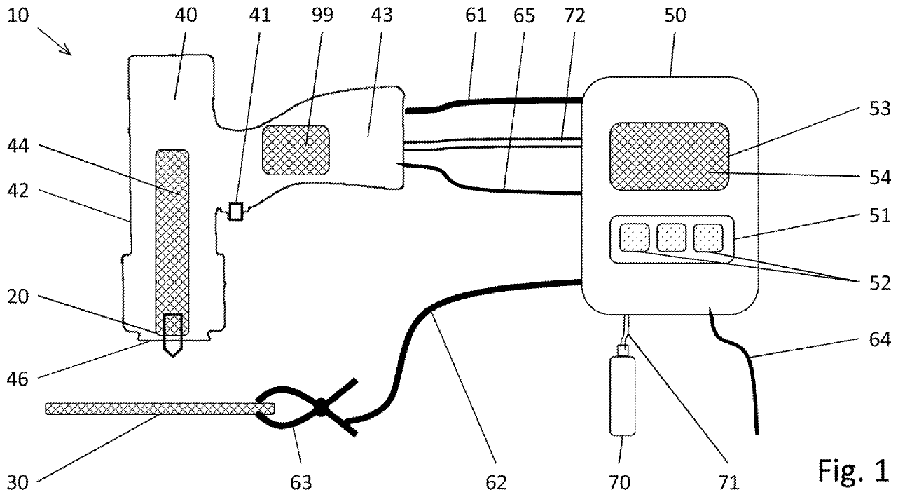

FIG. 1 schematically shows a welding device,

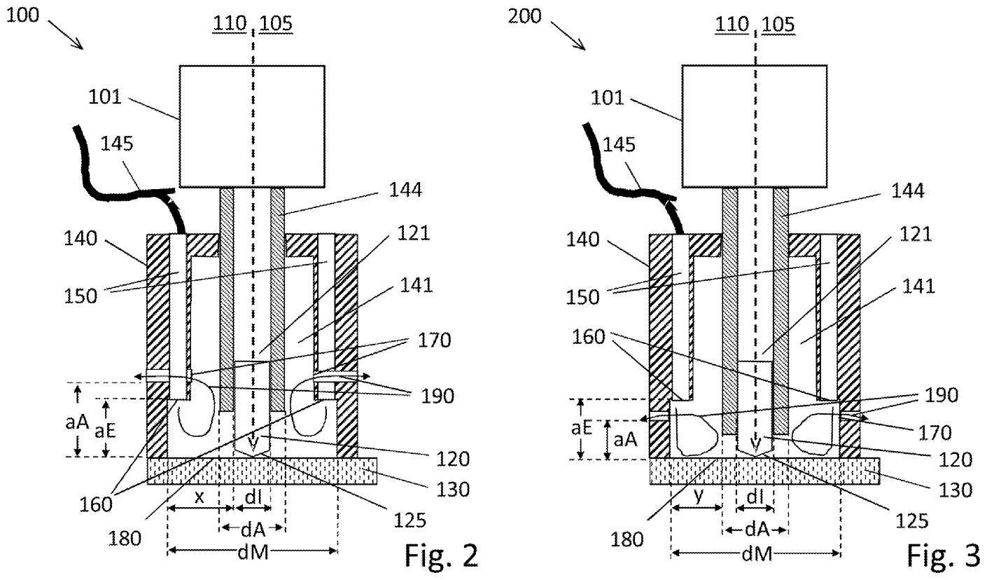

FIG. 2 schematically shows a welding device in a partial longitudinal sectional view, and

FIG. 3 schematically shows a welding device in a partial longitudinal sectional view.

In FIG. 1, a welding device 10 for welding a welding stud 20 to a substrate 30 is schematically shown. A material of the welding stud 20 and a material of the substrate 30 are electrically conductive, in particular metallic. The welding device 10 comprises a welding gun 40 with a trigger switch 41, formed as a pushbutton switch, a welding unit 50, a first electrical cable 61, a second electrical cable 62 with a connection terminal 63, an electrical supply cable 64, formed for example as a power cable, an electrical communication line 65, a gas reservoir 70, formed as a gas cylinder, a tubular gas supply line 71 and a gas hose 72.

The first cable 61 serves for supplying the welding stud 20 with electrical current through the welding unit 50. The second cable 62 serves for electrically connecting the substrate 30 to the welding unit 50 when the connection terminal 63 is clamped to the substrate 30. When the welding stud 20 comes into contact with the substrate 30, a circuit closes, so that welding current, for example in the form of direct current or alternating current, can be applied to the welding stud 20 through the welding unit 50. For this purpose, the welding gun 40 comprises a welding-current contact element that is not shown in FIG. 1. The welding unit 50 comprises a device that is not shown for converting electrical current from the supply cable 64 into welding current, which comprises for example an electrical capacitor, a thyristor, a bipolar transistor with an isolated gate electrode or other components from power electronics and also an associated control unit with a microprocessor, in order to provide the welding current at the desired voltage and current intensity.

The gas supply line 71 and the gas hose 72 serve for supplying a contact region between the welding stud 20 and the substrate 30 with an inert gas from the gas reservoir 70, in order to protect the contact region from oxidation due to oxygen from a surrounding area during a welding operation. For controlling a gas flow to the contact region, the gas reservoir the gas supply line 71, the welding unit 50, the gas hose 72 or the welding gun 40 comprises a valve (not shown), in particular a controllable valve.

The welding unit 50 has an input device 51 having actuating elements 52, and an output device 53 having a visual display element 54 and a wireless transmission unit. The input device 51 serves for the input of parameters of a welding method to be carried out with the welding device 10, for example the voltage, current intensity, power and time duration of the welding current, position and speed of the stud and so on, by a user of the welding device 10. The output device 53 serves to output information to the user, for example information about parameters of the welding method, information about detected emissions of the welding method or other variables, information about a quality of the welding operation, information about measures for improving the welding operation, information about detected characteristics of the welding stud, or information derived from the aforementioned variables, and/or recommendations or instructions for cleaning and/or maintaining the welding device 10, in particular the welding gun 40.

The communication line 65 serves for communication between the welding gun 40, in particular a control device of the welding gun 40 that is not shown in FIG. 1, and the welding unit 50, in particular the control unit and/or the input device 51 and/or the output device 53. By way of this communication, for example an exchange of information about the parameters of a welding operation is accomplished, in order for example to achieve synchronization of the welding current with a movement of the welding stud 20 or to make this easier. In exemplary embodiments that are not shown, the communication between the welding gun and the welding unit takes place wirelessly, by radio or by means of the first electrical cable, which carries the welding current.

The welding gun 40 has a housing 42 with an opening 46, from which a handle 43 having the trigger switch 41 protrudes. The welding gun 40 also has a stud holder 44, on which the welding stud 20 is held during a welding operation. For this purpose, the stud holder comprises for example two, three, four or more resilient arms (not shown in detail), between which the welding stud 20 is inserted and held by means of a clamping fit. For applying a welding current to the welding stud 20, the welding gun 40 also has a welding-current contact element, which is integrated in the stud holder 44, for example in the form of one or more of the resilient arms.

The welding gun 40 also has a control device 99 for controlling the various components and devices of the welding gun and of the welding unit 50. The control device 99 is intended for controlling one or more parameters of the welding operation. For this purpose, the control device 99 comprises various electronic components, for example one or more microprocessors, one or more temporary or permanent data memories, and the like.

The welding gun 40 also has a stud lifting device, which is formed as a first lifting magnet and acts on the stud holder 44 with a force rearwardly away from the opening 46 (upwardly in FIG. 1) when the stud lifting device is activated. Via a signal line (not shown), the control device 99 communicates with the stud lifting device in order to control the stud lifting device, in particular to activate and deactivate it.

The welding gun 40 also has a stud immersing device, formed as a spring element or as a second lifting magnet, which acts on the stud holder 44 with a force forwardly toward the opening 46 (downwardly in FIG. 1) when the stud immersing device is activated. Via a signal line (not shown), the control device 99 communicates with the stud immersing device in order to control the stud immersing device, in particular to activate and deactivate it. If the stud immersing device is formed as a spring element, this spring element is preferably tensioned when the stud holder is moved rearward by the stud lifting device, so that the spring element moves the stud holder forward as soon as the stud lifting device is deactivated.

In a welding method with the welding device 10, first the substrate 30 and the stud 20 are provided. In a further step, information, for example about desired parameters of the following welding operation, is input by a user via the input device. In a further step, a welding current between the welding stud 20 and the substrate 30 is applied to the welding stud 20 by the welding unit 50 by means of the first cable 61 and the second cable 62. In a further step, the welding stud 20 is lifted off the substrate by means of the stud lifting device while maintaining the welding current flowing between the welding stud 20 and the substrate 30, with an arc being formed between the welding stud 20 and the substrate 30. In particular on account of the heat generated by the arc, a material of the welding stud 20 and/or of the substrate 30 is then partially liquefied. In a further step, the welding stud 20 is immersed by means of the stud immersing device into the liquefied material of the welding stud 20 or of the substrate 30. The liquefied material of the welding stud 20 or of the substrate 30 then solidifies, so that the welding stud 20 is connected to the substrate 30 in an integrally bonded manner.

FIG. 2 schematically shows a longitudinal section of a welding device 100 which is intended for welding a welding stud 120 to a substrate 130 along a welding axis 105 in a welding direction 110. The welding device 100 is formed as a welding gun defining the welding direction 110. The welding device 100 has a holding device 144, formed as a stud holder, with an outside diameter dA, which holding device has a stud receptacle 121, with an inside diameter dl, for holding the welding stud 120 during a welding operation, into which the welding stud 120 can be inserted and is preferably held with a clamping action. A contact surface 125 of the welding stud 120 makes contact with the substrate 130 before and/or during the welding operation.

The welding device 100 comprises a schematically shown housing 101 with a handle (not shown) and a trigger switch (not shown) and also an inert gas cover 140, which is intended for being suffused with inert gas in order to suppress or completely prevent oxidation of the welding melt with oxygen from the ambient air. For this purpose, the inert gas cover 140 has an inert gas supply, which comprises a multiplicity of first connecting channels 150, arranged in the form of a ring around the welding axis 105. An inert gas hose 145 or the like, for supplying the inert gas cover 140, can be connected to the inert gas supply. Each of the first connecting channels 150 running axially with respect to the welding axis 105 opens with an inlet opening 160 into a main chamber 141 of the inert gas cover 140, so that the inlet openings 160 are likewise arranged in the form of a ring around the welding axis 105 and together form an inert gas inlet. In exemplary embodiments which are not shown, the inert gas inlet comprises a single inlet opening in the form of a ring surrounding the welding axis. Furthermore, the inert gas cover 140 has a multiplicity of outlet openings 170, which are likewise arranged in the form of a ring around the welding axis, lead radially with respect to the welding axis 105 through the inert gas cover 140 outward into the surrounding area and form an inert gas outlet. In a direction transverse to the welding axis 105 (in FIG. 2 perpendicularly to the plane of the drawing), in particular in the circumferential direction, the outlet openings 170 are respectively arranged offset from the inlet openings 160.

Furthermore, the inert gas cover 140 has an opening 180, which faces in the welding direction 110 and has transversely to the welding direction 110 an opening diameter dM. The inert gas inlet, to be specific the inlet openings 160, is/are at an inlet distance aE from the opening 180 counter to the welding direction 110. The inert gas outlet, to be specific the outlet openings 170, is/are at an outlet distance aA from the opening 180 counter to the welding direction 110.

The outlet distance aA is approximately half the size of a difference between the opening diameter dM and the inside diameter dl, that is to say approximately the same size as a radial distance x between the welding stud 120 and the inert gas cover 140. Furthermore, the outlet distance aA is greater than the inlet distance aE. When the opening 180 is covered by the substrate 130, inert gas flowing into the main chamber 141 through the inlet openings 160 flows along the flow paths 190 first to a radially outer region of the opening 180, then from all sides radially inward to the welding stud 120, and then substantially axially upward to the outlet openings 170. This causes the formation of a toroidal flow pattern, which is arranged radially symmetrically around the welding axis 105, and has the effect of uniformly and effectively suffusing the welding point at the welding stud 120 with inert gas. Ambient air, which for example only slowly escapes from the narrow gap between the holding device 144 and the inert gas cover (in FIG. 2 above the outlet openings 170), is entrained by the flow through the outlet openings 170 and is kept away from the welding point.

FIG. 3 schematically shows a longitudinal section of a welding device 200 which is substantially identical to the welding device 100 (FIG. 2). Identical elements have identical reference signs. The welding device 200 differs from the welding device 100 in particular by the arrangement of the inlet openings 160 and the outlet openings 170. The outlet distance aA is approximately half the size of a difference between the opening diameter dM and the outside diameter dA, that is to say approximately the same size as a radial distance y between the holding device 144 and the inert gas cover 140. Moreover, the outlet distance aA is smaller than the inlet distance aE, but more than half the size of the inlet distance aE. The outlet openings 170 are respectively arranged offset from the inlet openings 160 in the circumferential direction around the welding axis 105, such that an interaction between inert gas flowing in and flowing out is reduced.

The invention has been described on the basis of examples of a welding gun. In this case, the features of the described embodiments can also be combined as desired with one another within a single fastening device. It is pointed out that the device according to the invention is also suitable for other purposes.

1. A welding device for welding a welding stud to a substrate along a welding axis in a welding direction, comprising an inert gas cover with an inert gas inlet arranged in the form of a ring around the welding axis, with an inert gas outlet, and with an opening facing in the welding direction, wherein the opening has transversely to the welding direction an opening diameter, wherein the inert gas inlet is at an inlet distance from the opening counter to the welding direction, wherein the inert gas outlet is at an outlet distance from the opening counter to the welding direction, further comprising a holding device for holding the welding stud within the inert gas cover during a welding operation, wherein the holding device has an outside diameter and a stud receptacle with an inside diameter, wherein the outlet distance is at least half of a difference between the opening diameter and the outside diameter or is at least the same size as the inlet distance.

2. The welding device as claimed in claim 1, wherein the outlet distance is at least half of the difference between the opening diameter and the inside diameter or is at least the same size as the inlet distance.

3. The welding device as claimed in claim 1, wherein the outlet distance is at least half of the difference between the opening diameter and the outside diameter and is at least half the size of the inlet distance.

4. The welding device as claimed in claim 1, wherein the inert gas inlet is directed onto a radially outer region of the opening in order to generate a flow of inert gas along the opening radially to the setting axis when the opening is covered.

5. The welding device as claimed in claim 1, wherein the inert gas inlet comprises an inlet opening in the form of a ring surrounding the welding axis.

6. The welding device as claimed in claim 1, wherein the inert gas inlet comprises a multiplicity of inlet openings arranged in the form of a ring around the welding axis.

7. The welding device as claimed in claim 1, wherein the inert gas outlet comprises a multiplicity of outlet openings arranged in the form of a ring around the welding axis.

8. The welding device as claimed in claim 1, wherein the inert gas outlet leads radially with respect to the welding axis through the inert gas cover outward into the surrounding area.

9. The welding device as claimed in claim 1, wherein the inert gas outlet is arranged offset from the inert gas inlet in a direction transverse to the welding axis.

10. The welding device as claimed in claim 2, wherein the outlet distance is at least half of the difference between the opening diameter and the outside diameter and is at least half the size of the inlet distance.

11. The welding device as claimed in claim 2, wherein the inert gas inlet is directed onto a radially outer region of the opening in order to generate a flow of inert gas along the opening radially to the setting axis when the opening is covered.

12. The welding device as claimed in claim 3, wherein the inert gas inlet is directed onto a radially outer region of the opening in order to generate a flow of inert gas along the opening radially to the setting axis when the opening is covered.

13. The welding device as claimed in claim 2, wherein the inert gas inlet comprises an inlet opening in the form of a ring surrounding the welding axis.

14. The welding device as claimed in claim 3, wherein the inert gas inlet comprises an inlet opening in the form of a ring surrounding the welding axis.

15. The welding device as claimed in claim 4, wherein the inert gas inlet comprises an inlet opening in the form of a ring surrounding the welding axis.

16. The welding device as claimed in claim 2, wherein the inert gas inlet comprises a multiplicity of inlet openings arranged in the form of a ring around the welding axis.

17. The welding device as claimed in claim 3, wherein the inert gas inlet comprises a multiplicity of inlet openings arranged in the form of a ring around the welding axis.

18. The welding device as claimed in claim 4, wherein the inert gas inlet comprises a multiplicity of inlet openings arranged in the form of a ring around the welding axis.

19. The welding device as claimed in claim 5, wherein the inert gas inlet comprises a multiplicity of inlet openings arranged in the form of a ring around the welding axis.

20. The welding device as claimed in claim 2, wherein the inert gas outlet comprises a multiplicity of outlet openings arranged in the form of a ring around the welding axis.
